(19) United States
(12) Patent Application Publication
(10) Pub. No.: US 2006/0035677 A1
(43) Pub. Date: Feb. 16, 2006

(54) Disablement of external keys in a communication device

(76) Inventors: Naveen Aerrabotu, Gurnee, IL (US); William P. Alberth JR., Crystal Lake, IL (US); Patricia A. Robb, Prairie Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/916,035

(22) Filed: Aug. 11, 2004

(51) Int. Cl. H04B 1/38; H04M 1/00

(52) U.S. Cl. 455/565; 455/557

(57) ABSTRACT

A method (200) and an apparatus (300) for a communication device (102) having an opened position (104) and a closed position (106) for disabling external keys (306), which are accessible in the closed position (106), when the communication device (102) is in the closed position (106) are disclosed. When the communication device (102) is detected to be in the closed position (106), the external keys (306) are disabled but are re-enabled when an incoming call is received (216) or when an unlocking code is entered (218).

### FIELD OF THE INVENTION

The present invention generally relates to a usage of external keys of a communication device, and more specifically to external keys of a communication device having an opened position and a closed position for disabling functions.

### BACKGROUND OF THE INVENTION

As portable electronic devices become more advanced, these devices become capable of performing more user requested functions. For example, a cellular telephone is now commonly equipped with additional features such as a camera, a music player, and a personal digital assistant (“PDA”). However, due to the size of the cellular telephone, input keys that can be used for various available functions in the cellular telephone are normally placed in a limited area of one main surface area of the cellular telephone. To provide additional input keys, some cellular telephones are equipped with input keys located on the sides of the cellular telephone. For a foldable cellular telephone having an opened position and a closed position, its main keypad including the majority of input keys is inaccessible when the foldable cellular telephone is in the closed position. External keys of the foldable cellular telephone, including the side keys which are accessible when the foldable cellular telephone is in the closed position, play an important role in enabling a user to invoke a desired available function even when the foldable cellular telephone is in the closed position. For example, the user may be able to take a picture using the camera and an external display as a view finder without opening the foldable cellular telephone using the external keys. However, when the user stores the foldable cellular telephone in his/her pocket or bag, the external keys of the foldable cellular telephone may be accidentally or unintentionally pressed and accidentally activate some features of the foldable cellular telephone, such as the camera and the external view finder, and drain the battery.

### BRIEF DESCRIPTION OF THE DRAWINGS

FIG. 1 is an exemplary block diagram of a communication device illustrating an opening position and a closed position of the communication device in accordance with at least one of the preferred embodiments;

FIG. 2 is an exemplary flowchart illustrating a process in the communication device for disabling the external keys in accordance with at least one of the preferred embodiments; and

FIG. 3 is an exemplary block diagram of the communication device in accordance with at least one of the preferred embodiments.

### DETAILED DESCRIPTION OF THE PREFERRED EMBODIMENTS

The present invention provides a method and an apparatus for a communication device having an opened position and a closed position for disabling external keys while the communication device is in the closed position to prevent accidental activations of functions that are normally accessible using the external keys. When the configuration of the communication device is changed from the opened position to the closed position, the communication device automatically disables the external keys after a predetermined period of time. Once the external keys are disabled, the external keys cannot be used to activate functions normally associated with the external keys, thereby preventing accidental actuation of the functions. The external keys may be re-enabled by changing the configuration of the communication device including changing back to the opened position and attaching an accessory device. The external keys may be re-enabled, without changing the configuration of the communication device, by actuating particular external keys in a certain way, such as pressing two keys simultaneously and pressing a plurality of external keys in a certain sequence. Then, some functions, which are desirable in the closed position, can be activated using the re-enable external keys. The external keys may further be re-enabled upon receiving an incoming call including an incoming message such as a Short Message Service (“SMS”) message and a Cell Broadcast message, and upon an occurrence of a scheduled event such as a Date book event and other synchronous events.

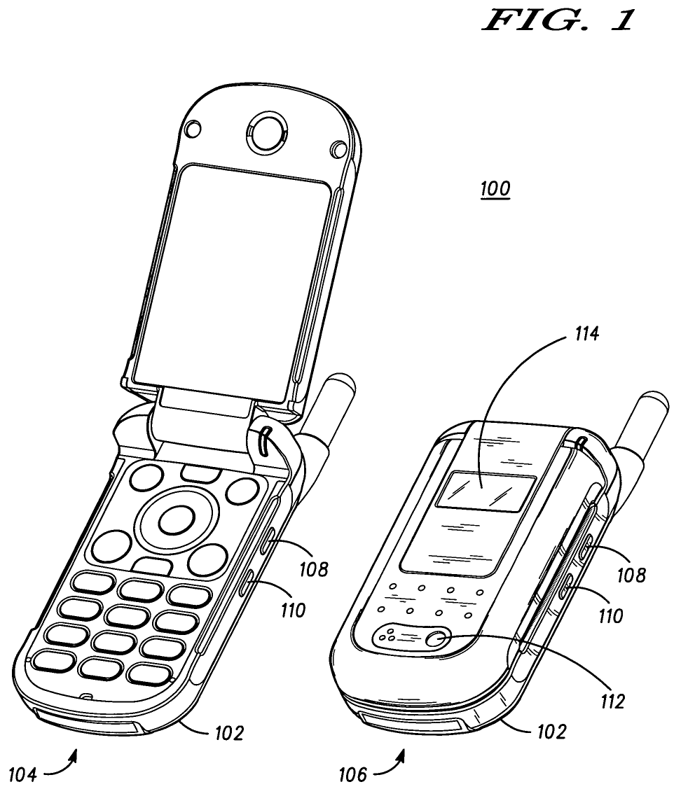

FIG. 1 is an exemplary block diagram 100 of a communication device 102 illustrating an opened position 104 and a closed position 106 of the communication device 102 in accordance with at least one of the preferred embodiments. Although the communication device 102 is shown as a foldable communication device in this example, the communication device 102 could have other form factors such as, but not limited to, being rotable and being slidable. The communication device 102 has a plurality of external keys (for simplicity, only two external keys 108, and 110 are shown). In this example, the communication device 102 is equipped with a camera 112 and an external display 114, which functions as a viewfinder for the camera 112 when the communication device 102 in the closed position 106. The camera 112 and the external display 114 can be activated by the external key 108. While the external keys 108 and 110 are shown on the same side of the communication device 102, they may be located on different or opposite sides of the communication device 102.

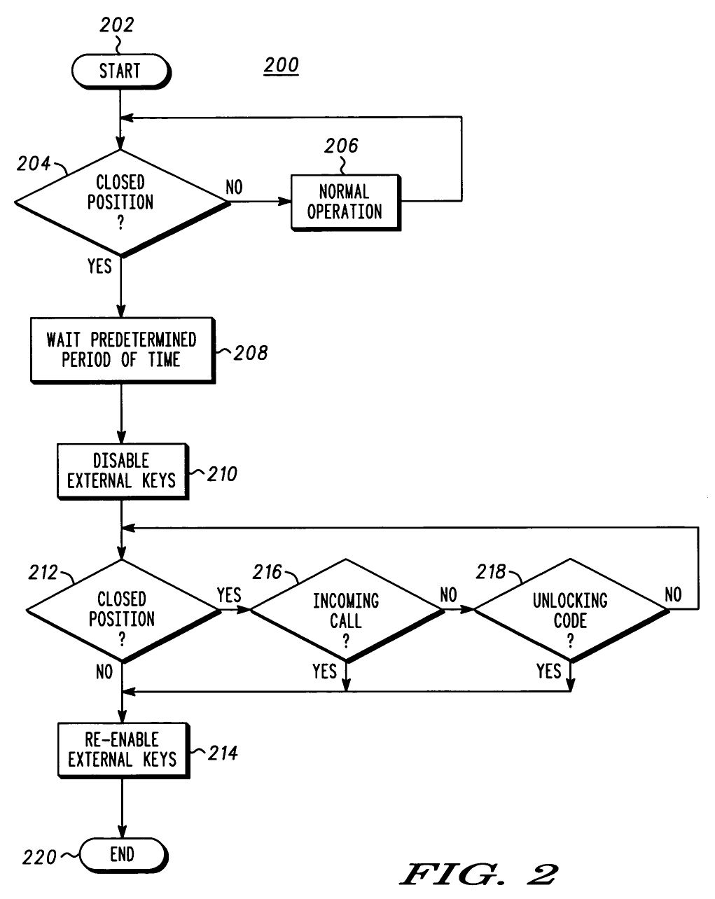

FIG. 2 is an exemplary flowchart 200 illustrating a process in the communication device 102 for disabling the external keys 108 and 110 in accordance with at least one of the preferred embodiments. The process begins in block 202, and whether the communication device 102 is in the closed position 106 is determined in block 204. If the communication device 102 is determined not to be in the closed position 106 in block 204, then the communication device 102 continues to function normally in block 206, and the process returns to block 204. If the communication device 102 is determined to be in the closed position 106 in block 204, then the communication device 102 waits for a predetermined period of time, such as 10 seconds, in block 208, and disables at least one of the external keys 108 and 110 in block 210. The disabled external keys 108 and 110 are re-enabled under certain conditions. In block 212, whether the communication device 102 is in the opened position 104 is determined. If the communication device 102 is determined to be in the opened position 104 in block 212, then the external keys 108 and 110 are re-enabled in block 214. In block 212, whether the communication device 102 has received an accessory attachment may also be check. If the communication device 102 is determined to have received an accessory attachment in block 212, then the external keys 108 and 110 may be re-enabled in block 214. If the communication device 102 is determined not to be in the opened position 104 in block 212, then whether the communication device 102 is receiving an incoming call is determined in block 216. An incoming call includes an incoming message such as a Short Message Service (“SMS”) message and a Cell Broadcast message. Alternatively, whether an occurrence of a pre-scheduled event, such as a Date book event and other asynchronous events, has occurred may be checked in block 216. If there is an incoming call, then the external keys 108 and 110 are re-enabled in block 214. If there is no incoming call, then whether an unlocking code has been entered is determined in block 218. When the external keys are disabled, they may not be completely disabled such that they become incapable of performing any function. Rather, when the external keys are disabled, the external keys cannot be used to recall normally available functions through simple actions of the external keys, such as pressing one external key to activate the viewfinder, to take a picture, to activate a speaker phone, or to activate an audio recorder. However, the external keys may still be used to re-enable the external keys. For example, two particular external keys may be pressed simultaneously or a particular set of external keys may be pressed in a certain sequence as an unlocking code. If the unlocking code has been entered, then the external keys 108 and 110 are re-enabled in block 214. If the unlocking code has not been entered, the process returns to block 212. The process then terminates in block 220.

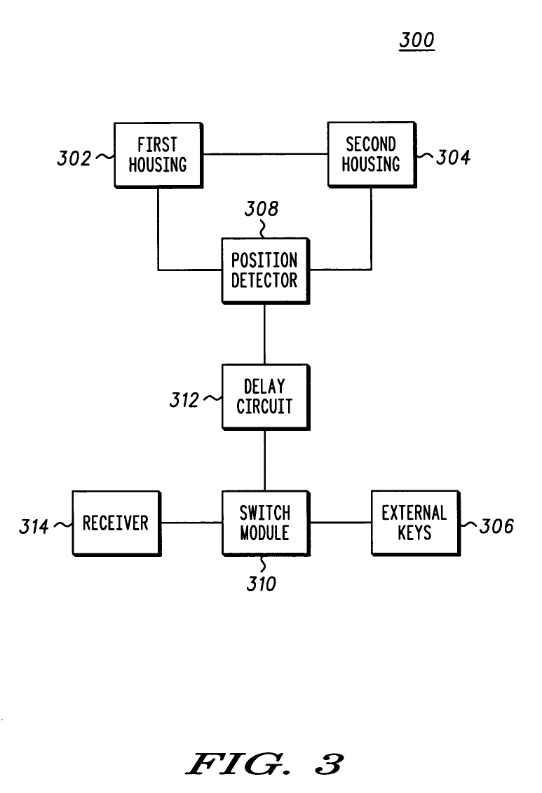

FIG. 3 is an exemplary block diagram 300 of the communication device 102 in accordance with at least one of the preferred embodiments. The communication device 102 has a first housing 302 and a second housing 304, which are hinged together such that the communication device can be configured in the opened position 104 or the closed position 106 as shown in FIG. 1. As previously described, the first housing 302 and the second housing 304 may move in a method other than folding such as, but not limited to, rotating or sliding relative to each other. The communication device 102 also has external keys 306, which includes the external keys 108 and 110 as shown in FIG. 1. The external keys 306 are accessible when the communication device 102 is in the closed position 106. A position detector 308, which is coupled to the first housing 302 and the second housing 304, is configured to determine whether the communication device 102 is in the opened position 104 or in the closed position 106. A switch module 310 is coupled to the external keys 306 to disable the external keys 306 when the position detector 308 determines that the communication device 102 is in the closed position 106. A delay circuit 312 is coupled to both the position detector 308 and the switch module 310, and delays disabling of the external keys 306 for a predetermined period of time when the position detector 308 determines that the communication device 102 is in the closed position 106. The switch module 310 is further configured to re-enable the external keys 306 when the position detector 308 determines the communication device 102 is in the opened position 104. A receiver 314 of the communication device 102 is also coupled to the switch module 310, and provides an incoming call notice to the switch module 310 when the receiver 314 receives an incoming call. If the communication device 102 is in the closed position 106 when the incoming call is received, the switch module 310 re-enables the external keys 306. As previously described, when the external keys 306 are disabled, they may not be completely disabled, and may be used to generate an unlocking code to re-enable the external keys. For example, two particular external keys may be pressed simultaneously or a particular set of external keys may be pressed in a certain sequence as an unlocking code.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a communication device having an opened position and a closed position, the method comprising:
detecting the communication device in the closed position; and
disabling at least one external key accessible in the closed position upon detecting the communication device in the closed position.

2. The method of claim 1, wherein disabling the at least one external key includes preventing at least one function associated with the at least one external key from being invoked upon actuating the at least one external key.

3. The method of claim 2, wherein disabling the at least one external key includes delaying disabling the at least one external key for a predetermined period of time.

4. The method of claim 2, further comprising:
after disabling the at least one external key, re-enabling the at least one external key upon at least one of:
detecting the communication device in the opened position;
detecting an accessory device being attached;
receiving an incoming call; and
an occurrence of a pre-scheduled event.

5. A method in a communication device having an opened position and a closed position, the communication device having a plurality of external keys accessible in the closed position, the method comprising:
detecting the communication device in the closed position;
disabling at least one external key of the plurality of external keys upon detecting the communication device in the closed position; and
re-enabling the at least one external key upon detecting the communication device in the opened position.

6. The method of claim 5, wherein disabling the at least one external key includes preventing at least one function associated with the at least one external key from being invoked upon actuating the at least one external key.

7. The method of claim 6, wherein disabling the at least one external key includes delaying disabling the at least one external key for a predetermined period of time.

8. The method of claim 6, further comprising:
after disabling the at least one external key, re-enabling the at least one external key by at least one of:
simultaneously actuating a second set of external keys of the plurality of external keys;
actuating a first set of external keys of the plurality of external keys in a predetermined sequence;
detecting an accessory device being attached;
receiving an incoming call; and
an occurrence of a pre-scheduled event.

9. A method in a handheld electronics device having hinged housing portions, the method comprising:
pivoting the hinged housing portions from an opened configuration to a closed configuration; and
disabling at least one user interface key located on an exterior portion of the handheld electronics device upon the pivoting the hinged housing portions from the opened configuration to the closed configuration; and
enabling the at least one user interface key when the housing portions of the handheld electronics device are in the opened configuration.

10. The method of claim 9, wherein disabling the at least one user interface key includes delaying disabling the at least one user interface key for a specified time-out period after the pivoting the hinged housing portions from the opened configuration to the closed configuration.

11. The method of claim 9, wherein the handheld electronics device includes at least two user interface keys located on the exterior portion of the handheld electronics device, and
after disabling the at least one user interface key, enabling the at least one user interface key when the hinged housing portions are in the closed configuration by actuating the at least two user interface keys.

12. The method of claim 11, wherein actuating the at least two user interface keys includes at least one of:
actuating the at least two user interface keys simultaneously; and
actuating the at least two user interface keys in a particular sequence.

13. The method of claim 9, further comprising:
after disabling the at least one user interface key, enabling the at least one user interface key upon at least one of:
pivoting the hinged housing portions from the closed configuration to the opened configuration;
detecting an accessory device being attached;
receiving an incoming call; and
an occurrence of a pre-scheduled event.

14. A communication device having an opened position and a closed position, the communication device having a first housing, a second housing hinged to the first housing, and at least one external key configured to initiate an associated function upon an actuation, the at least one external key accessible in the closed position, the communication device comprising:
a position detector coupled to the first and second housings, the position detector configured to determine whether the communication device is in one of the opened position and the closed position; and
a switch module coupled to the at least one external key and the position detector, the switch module configured to disable the at least one external key when the position detector determines the communication device is in the closed position.

15. The communication device of claim 14, further comprising:
a delay circuit coupled to the position detector and the switch module, the delay circuit configured to delay the disablement of the at least one external key for by a delay time after the position detector determines the communication device in the closed position.

16. The communication device of claim 14, wherein the switch module is further configured to re-enable the at least one external key when the position detector determines the communication device is in the opened position.

17. The communication device of claim 14, further comprising:
a receiver coupled to the switch module, the receiver configured to receive an incoming call and to provide an incoming call notice to the switch module upon receiving the incoming call,
wherein the switch module is further configured to re-enable the at least one external key upon receiving the incoming call notice when the communication device is in the closed position.

18. The communication device of claim 14, further comprising:
a plurality of external keys coupled to the switch module, the plurality of external keys including the at least one external key accessible in the closed position, each of the plurality of external keys configured to initiate an associated function upon actuation,
wherein the switch module is further configured to re-enable the at least one external key upon an actuation of a set of external keys of the plurality of external keys when the communication device is in the closed position.

19. The communication device of claim 18, wherein the actuation of the set of the plurality of external keys includes at least one of:
a simultaneous actuation of the set of external keys, and
a sequential actuation of the set of external keys.
